(19) United States
(12) Patent Application Publication
(10) Pub. No.: US 2025/0124316 A1
(43) Pub. Date: Apr. 17, 2025

(54) AUTOMATICALLY MIXING USAGE OF MULTIPLE GENERATIVE MACHINE LEARNING (ML) MODELS WITH DIFFERING COMPUTATIONAL EFFICIENCIES

(71) Applicant: GOOGLE LLC, Mountain View, CA (US)

(72) Inventors: Srividya Pranavi Potharaju, Union City, CA (US); Shyam Upadhyay, El Paso, TX (US); Aman Madaan, Sunnyvale, CA (US); Ankit Anand, Montreal (CA); Manaal Faruqui, Brooklyn, NY (US)

(21) Appl. No.: 18/899,988

(22) Filed: Sep. 27, 2024

Related U.S. Application Data
(60) Provisional application No. 63/543,913, filed on Oct. 12, 2023.

(51) Int. Cl. G06N 7/01

(52) U.S. Cl. CPC G06N 7/01

(57) ABSTRACT

Various implementations are directed towards generating, based on processing language model (LM) input using a first LM, an initial response that is predicted to be responsive to natural language (NL) based input, where the LM input includes at least the NL based input. Additionally or alternatively, the system can determine whether to generate an additional response based on processing the LM input using a second LM, where determining whether to generate the additional response includes processing at least the LM input and initial response using at least one verifier to generate a verification score. In many implementations, the verification score can be processed using a meta-verifier to determine whether to render output based on the initial response or the additional response.

### BACKGROUND

Various generative models have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects generative NL content and/or other generative content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”. However, current utilizations of generative models suffer from one or more drawbacks.

As one example, many generative models can be of a very large size, often including billions of parameters (e.g., over 100 billion parameters, over 250 billion parameters, or over 500 billion parameters). Due to the large size of such a generative model, significant memory, processor, power, and/or other computational resource(s) can be required to process an input, using the generative model, to generate a corresponding generative output. This resource utilization can be significant on a per input basis, and very significant when hundreds or thousands of inputs are being processed per minute, per second, or other interval. Also, due to the large size of such a generative model, there can be significant latency in generating a corresponding generative output and, as a result, in rendering corresponding generative content. Such latency can lead to prolonging of a user-to-computer interaction.

Smaller size counterparts to such generative models do exist, such as a separately trained counterpart with less parameters or a pruned and/or quantized counterpart generated from applying one or more pruning techniques and/or one or more quantization techniques to the larger counterpart. For example, a smaller counterpart to a larger model can include 25%, 33%, 50%, 66% or other percentage less parameters than the larger model. However, such smaller size counterparts can be less robust and/or less accurate than their larger size counterparts. While utilizing such a smaller size counterpart to process an input can be more computationally efficient and/or can be performed with less latency, there is a greater risk that corresponding generative output, generated by processing the input, can be inaccurate and/or under-specified. Nonetheless, such a smaller size counterpart may be sufficient for processing some content. Accordingly, there is a need in the art to automatically mix usage of smaller generative models and larger generative models, in processing given NL content and/or other input(s), to balance the latency and computational resource consumption benefits of these smaller generative models with the robustness and accuracy benefits of these larger generative models.

### SUMMARY

Implementations described herein are directed to automatically mixing usage of multiple generative machine learning (ML) models with differing computational efficiencies in generating a response to a given natural language (NL) based input. Processor(s) of a system can: receive natural language (NL) based input associated with a client device of a user; generate, based on processing language model (LM) input (e.g., that includes at least the NL based input) using a first LM, an initial response that is predicted to be responsive to the NL based input; and determine, based on processing at least the initial response, whether to cause the initial response to be rendered at the client device or whether to generate an additional response that is also predicted to be responsive to the NL based input and that is generated based on processing the LM input using a second LM that is in addition to the first LM. In response to determining to cause the initial response to be rendered at the client device, the system can cause the initial response to be visually and/or audibly rendered at the client device. However, and in response to determining to generate the additional response, the system can generate, based on processing the LM input using the second LM, the additional response; and cause the additional response, and in lieu of the initial response, to be visually and/or audibly rendered at the client device.

Notably, the first LM can be a smaller language model (SLM), whereas the second LM can be a larger language model (LLM). The SLM can be considered “smaller” relative to the LLM in that it includes fewer parameters and/or is more computationally efficient. Accordingly, the system can generate the initial response using the SLM in an attempt to generate a suitable response and without having to invoke the LLM. However, if the initial response generated using the SLM is determined to be insufficient (e.g., as indicated by the at least one verifier and the meta-verifier), the system can then invoke the LLM without any user intervention from the user of the client device or other users. Accordingly, the present disclosure automatically mixed usage of at least the SLM and the LLM, in processing the NL based input, to balance the latency and computational resource consumption benefits of the SLM with the robustness and accuracy benefits of the LLM.

In various implementations, and in determining whether to cause the initial response to be rendered at the client device or whether to generate the additional response, the system can process, using at least one verifier, at least the LM input and the initial response to generate a corresponding verification score for the initial response. Further, the system can process, using a meta-verifier that is in addition to the at least one verifier, the corresponding verification score for the initial response to determine whether to cause the initial response to be rendered at the client device or whether to generate the additional response. In these implementations, the corresponding verification score that is generated by the at least one verifier can be noisy. Accordingly, the meta-verifier serves as an additional verification mechanism to vet any determinations made by the at least one verifier.

In some versions of those implementations, the first LM can serve as the at least one verifier. In these implementations, and, subsequent to generating the initial response, the system can process, using the first LM, at least the LM input and the initial response to generate the corresponding verification score for the initial response. In additional or alternative versions of those implementations, an independent verifier that is in addition to both the first LM and the second LM can serve as the at least one verifier. In these implementations, and, subsequent to generating the initial response, the system can process, using the independent verifier, at least the LM input and the initial response to generate the corresponding verification score for the initial response.

In some further versions of those implementations, and in generating the corresponding verification score, the first LM can additionally process a context (e.g., a client device context associated with context of the client device of the user, a user context associated with context of the user of the client device, a dialog context associated with context of an ongoing dialog of the user of the client device, etc.) and/or an instruction to evaluate the initial response given at least the LM input and the initial response (e.g., a verification prompt utilized to perform the verification as an entailment task). Notably, the corresponding verification score can be a corresponding binary measure or a corresponding non-binary numerical measure that indicates whether the initial response is responsive to the NL based input.

In some versions of those implementations, an independent meta-verifier that is in addition to both the first LM and the second LM can serve as the meta-verifier. The meta-verifier can be a simple classifier or a Partially Observable Markov Decision Making Process-based (POMDP-based) classifier. In implementations where the independent meta-verifier is the simple classifier, the system can process, using the simple classifier, the corresponding binary measure or the corresponding non-binary numerical measure, that indicates whether the initial response is responsive to the NL based input, to generate simple classifier output, and determine whether simple classifier output satisfies a threshold. If the simple classifier output satisfies the threshold, then the system can determine to cause the initial response to be rendered at the client device. However, if the simple classifier output does not satisfy the threshold, then the system can determine to generate the additional response and then cause the additional response to be rendered at the client device and in lieu of the initial response.

In implementations where the independent meta-verifier is the POMDP-based classifier, the system can process, using the POMDP-based classifier, POMDP input to determine a classification. The POMDP input can include, for example, the corresponding binary measure or the corresponding non-binary numerical measure, that indicates whether the initial response is responsive to the NL based input, the LM input, the initial response, and/or other content. Further, the classification can include, for example, one of: a simple classification, a complex classification, or an unsolvable classification. If the classification is the simple classification or the unsolvable classification, the system can determine to cause the initial response to be rendered at the client device. Put another way, if the system determines that the initial response generated by the first LM should be sufficient based on the simple classification or that any additional response generated by the second LM would still be insufficient based on the unsolvable classification, then the system can refrain from generating the additional response. However, if the classification is the complex classification, the system can determine to cause the additional response to be generated. Put another way, if the system determines that the initial response generated by the first LM is insufficient, but that the second LM is capable of generating an additional response that would be sufficient, then the system can proceed with generating the additional response using the second LM.

As one non-limiting example of techniques described herein, assume that a user of a client device provides NL based input of “what are some common ways to reduce stress?” In this example, the system can process, using the first LM, the NL based input (and optionally any context) to generate first LM output, and determine the initial response based on the first LM output. Further assume that the initial response includes a bullet point list indicating the user should exercise regularly, get enough sleep, eat a healthy diet, and so on. In this example, and in processing the initial response, the verifier and/or the meta-verifier are likely to determine that the initial response is sufficient since it includes some clear and concise tips for common ways to reduce stress in humans. Accordingly, the system can cause the bullet point list generated using the first LM to be rendered at the client device.

In contrast, assume that a user of a client device provides NL based input of “write a plan for a 4 year old to get into Stanford after high school” In this example, the system can process, using the first LM, the NL based input (and optionally any context) to generate first LM output, and determine the initial response based on the first LM output. Further assume that the initial response includes a bullet list indicating the user should graduate from high school and apply to Stanford. In this example, and in processing the initial response, the verifier and/or the meta-verifier are likely to determine that the initial response is insufficient since it includes only a two-step plan to get into Stanford (i.e., graduate from high school and apply to Stanford). Put another way, the plan lacks any details of particular high school courses, particular extracurricular activities, particular application requirements, and so on that would typically be required to be admitted to Stanford. Accordingly, the system can cause the second LM to generate the additional response (e.g., with a more specific plan for a 4 year old to get into Stanford after high school) and then cause the additional response to be rendered at the client device.

Although the above implementations are described with respect to only the first LM and the second LM, it should be understood that is for the sake of example and is not meant to be limiting. Rather, it should be understood that additional LMs having different quantities of parameters and/or different computational efficiencies can be configured to optimize balancing of the latency and computational resource consumption benefits of different SLMs with the robustness and accuracy benefits of different LLMs.

By using the techniques described herein, various technical advantages can be achieved. As one non-limiting example, by automatically mixing usage of multiple LMs with different computational efficiencies, latency and computational resource consumption of the SLM can be balanced with the robustness and accuracy benefits of the LLM. For example, if the SLM generates an initial response that is suitable for being rendered responsive to an NL based input, then the initial response can be rendered without invoking the LLM. However, if the initial response is not suitable for being rendered responsive to an NL based input, then the LLM can be invoked to generate an additional response that is suitable for being rendered responsive to an NL based input.

The above description is provided as an overview of only some implementations disclosed herein. These and other implementations are described in more detail herein, including in the detailed description and the claims.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A illustrates an example of rendering an initial response in accordance with various implementations.

FIG. 1B illustrates an example of rendering an additional response in accordance with various implementations.

FIG. 2 illustrates a flowchart depicting an example process in accordance with various implementations.

FIG. 3 illustrates a flowchart depicting another example process in accordance with various implementations.

FIG. 4 illustrates an example environment in which various implementations disclosed herein may be implemented.

FIG. 5 illustrates an example architecture of a computing device.

### DETAILED DESCRIPTION

Large language models (LLMs) are available in various sizes and configurations (e.g., LLMs available from cloud API providers). While this diversity offers a broad spectrum of choices, effectively leveraging the options to optimize computational cost and performance remains can be challenging. In some implementations, a system can use AutoMix, an approach that strategically routes queries to larger language models (LMs), based on the approximate correctness of outputs from a smaller LM. In some of those implementations, AutoMix uses a few-shot self-verification mechanism, which estimates the reliability of its own outputs without requiring training. Given that verifications can be noisy, AutoMix can use a meta-verifier to refine the accuracy of these assessments.

Tasks have an intrinsic complexity and variability, from simplistic (e.g., binary classification on separable data) to complex (e.g., code generation) and potentially unsolvable (e.g., certain forms of multi-step reasoning). In some implementations, AutoMix iteratively queries over models of disparate sizes and capabilities, verifying feedback at each step and/or determining whether to accept the output or route to a more capable, albeit computationally intensive, model.

Existing model-switching approaches predominantly rely on separate models trained explicitly for each step and/or require access to logits, which may not always be feasible as LLMs often rely on access to black box APIs. Accordingly, implementations described herein are directed towards AutoMix, which can fully leverage black-box LLM APIs, avoiding the need for separate models or access to logits. In some of those implementations, AutoMix approaches use few-shot learning and/or meta-verification in leveraging black-box LLM APIs. In contrast to existing approaches which generally delineate tasks as Simple or Complex for model routing, AutoMix integrates a third category of Unsolvable queries. In some implementations, unsolvable queries are likely unsolvable even by a Large Language Model (LLM) and should not be routed to larger models if identified early enough. In some versions of those implementations, identifying unsolvable queries (and consequently not processing the unsolvable queries using the language models) allows AutoMix to judiciously allocate computational resources, preventing unwarranted computational spending on these particularly challenging instances.

Additionally or alternatively, AutoMix can use context-grounded few-shot entailment to quantify the uncertainty in an answer's correctness. However, recognizing that verifications can sometimes be inconsistent and/or noisy, AutoMix includes a meta-verifier to evaluate the reliability of the initial verification. In some implementations, the meta-verifier acts as a secondary check, providing an additional layer of confidence assessment to ensure that the decision to route a task to a larger or smaller model is well-founded.

In some implementations, AutoMix can strategically leverage black-box LLM APIs for generating a solution, verifying the solution, and/or switching to a larger language model, without access to the LLMs weights, gradients, and/or logits. In some implementations, context-grounded entailment can be used as a reasonable (albeit noisy) proxy for self-verification. In some of those implementations, to deal with this noise, AutoMix uses a Partially Observable Markov Decision Process (POMDP) based meta-verification mechanism to increase the reliability of the decision of whether to process the query using an additional language model.

In some implementations, the verification process can be framed as a natural language entailment task, where the model determines the validity of the model-generated answer with respect to the context and/or question. For example, a verification prompt can include:
Context: {context}
Question: {question}
AI Generated Answer: {generated_answer}
Instruction: Your task is to evaluate if the AI Generated Answer is correct, based on the provided context and question. Provide the judgment and reasoning for each case. Choose between Correct or Incorrect.
Evaluation: “‘

In some implementations, AutoMix can be used in context-grounded question answering, where a given context C (e.g., stories, newswire(s), research article(s), one or more additional or alternative contexts, and/or combinations thereof) and a question q, the language model is tasked to generate accurate and/or coherent answer(s), consistent with the provided context. In some implementations, AutoMix includes two distinct language models: a smaller, cost-efficient model (SLM) and a larger, more accurate but costly model (LLM). The system can balance answer accuracy with computational resource usage (e.g., memory, processor cycles, power, etc.). A verifier, V, can process the output generated using the SLM (e.g., the initial output) to determine whether the query should be directed to the LLM for additional processing. In some implementations, the system can generate an initial answer (e.g., the initial output), A_{S} using the smaller SLM. In some of those implementations, the system can determine the trustworthiness of A_{S} using the few-shot verifier V. It is generally more computationally expensive to process longer queries using a language model. In some implementations, AutoMix can be used to balance the computational cost to process a longer query with the accuracy of the answer to the query. Additionally or alternatively, context can be used by the verifier to cross check the preliminary answer(s) with available information, which can aid in identifying inconsistencies as ungrounded.

In some implementations, verification is framed as an entailment task with the objective to determine if the answer generated by the SLM aligns with the provided context. Specifically, the verifier gauges v=p(correct=1|A_{S}, C, q), where correct=1 indicates A_{S} is correct. In some implementations, the verification prompt is framed as a natural language entailment task, where the model determines the validity of the model-generated answer with respect to the context and question. In some of those implementations, a generic few-shot prompt can be used for all tasks.

However, the verification output generated using the verifier(s) has the potential for inconsistency and/or noise. In some implementations, a meta-verifier can be used as a secondary evaluation mechanism to vet the verifier's conclusions. In some implementations, the verifier is tasked with determining whether the initial response generated using the SLM is entailed by the context. This decision can be made without considering the inherent difficulty of the problem. Notably, routing unsolvable queries for the LLM is resource-inefficient without enhancing performance. While ascertaining the ground truth of query difficulty is non-trivial, verification probability and/or historical data can provide insightful guidance. In some implementations, the meta-verifier's output can be defined as m(v, A_{S}, C, q)Δ{0, 1}, where m=1 indicates the verifier's output can be trusted.

In some implementations, a non-LLM process can be used for meta-verification to avoid escalating issues like hallucination and/or reasoning errors. The meta-verifier can adopt various advanced learning strategies, from supervised to reinforcement learning.

For example, a thresholding method can be used with the meta-verifier, where the decision is made based on the probability of the one or more verifier's output being correct with a threshold t, defined as H(t)=0 for t<0 and H(t)=1 for t≥0. In some of those implementations (e.g., black-box language models), the probability of correctness can be derived by sampling k>1 samples at a higher sampling temperature.

In some implementations, in the context of the meta-verifier, queries can be categorized in three categories: Simple, Complex, and Unsolvable. Simple queries can be addressable by the SLM, complex queries are addressable by the LLM but not by the SLM, and unsolvable queries are so complex that they can't be addressed by either the LLM or the SLM. In some of those implementations, the system should route only the complex queries but not unsolvable queries to the LLM. Since the ground truth state is not known and/or is unobserved, the system can formulate this decision problem as a Partially Observable Markov Decision Process (POMDP). POMDP offers a structured way to manage and navigate through the decision spaces where the system's state is not fully observable. For example, a POMDP can be defined by a tuple (S, A, T, R, Ω, O) where S is a set of states, A is a set of actions, T represents the state transition probabilities, R is the reward function, Ω is a set of observations, and O is the observation function.

Additionally or alternatively, the POMDP-based meta-verifier can have interpretability and/or customizability via reward assignment. For instance, in a complex state, assigning a reward of +50 for invoking the LLM indicates a preference for accurate solutions over computational cost. Although the POMDP framework (inherently) handles sequences of decisions, the system described herein is confined to a single-decision scenario (horizon or episode length 1) for simplicity, with potential for extension to streaming settings for optimizing across multiple queries or a fixed time duration.

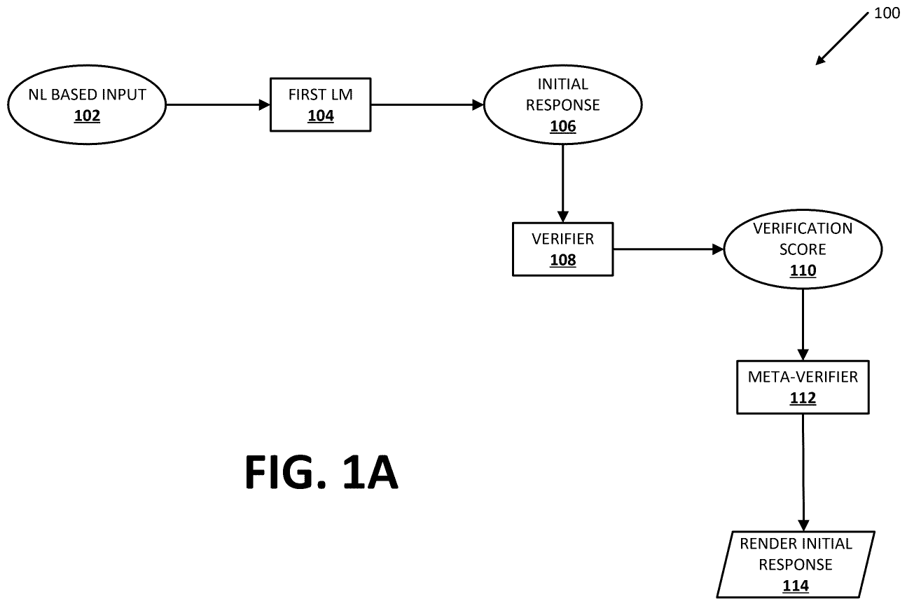

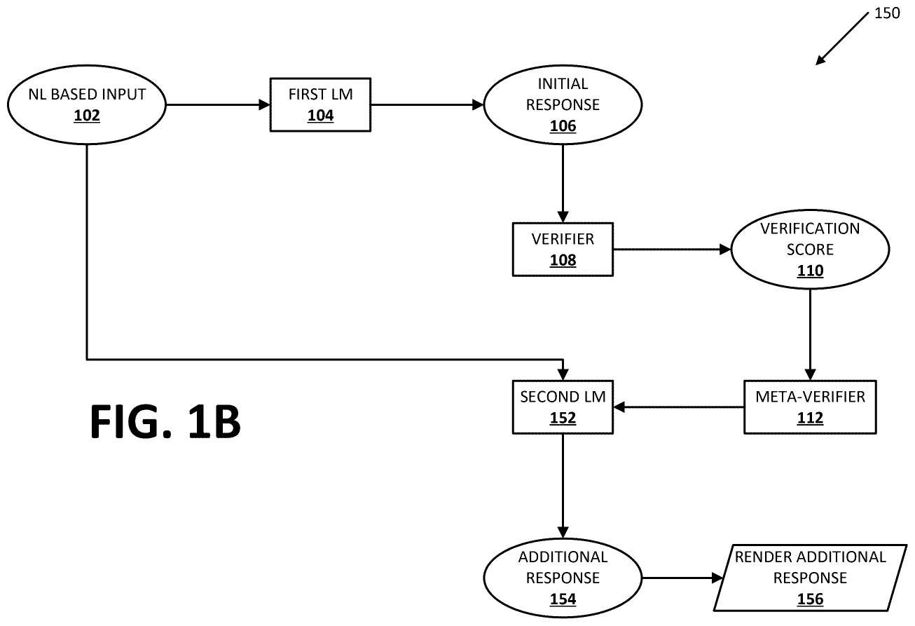

Turning now to the figures, FIG. 1A illustrates an example 100 of rendering an initial response in accordance with various implementations. Example 100 includes processing NL based input 102 using first LM 104 to generate an initial response 106. In some implementations, the NL based input 102 includes text based NL input provided by a user, a text representation of a spoken utterance of a user, etc. Additional or alternative input can be provided as LM input (not depicted) to the first LM 104 in addition to the NL based input 102. In some of those implementations, the LM input can include the NL based input, context input, an instruction to evaluate the initial response, one or more additional or alternative inputs, and/or combinations thereof. For example, the context input can include a client device context (associated with the context of the client device of the user), a user context (associated with the context of the user of the client device), a dialog context (associated with context of an ongoing dialog of the user of the client device), additional or alternative context, and/or combinations thereof.

In some implementations, the first LM 104 can be the smaller language model (SLM), where the first LM 104 is “smaller” relative to the second LM (the larger language model) in that it includes fewer parameters and/or is more computational efficient. The initial response 106 is natural language text responsive to the NL based input 102, where the initial response 106 is generated based on processing the NL based input 102 using the first LM 104.

Additionally or alternatively, the verifier 108 can process the initial response 106 to generate verification score 110 indicating whether the initial response 108 is responsive to the NL based input 102. For example, the verification score 110 can be a binary indication of whether the initial response is responsive to the NL based input, a non-binary numerical indication of whether the initial response is responsive to the NL based input, one or more additional or alternative indications, and/or combinations thereof.

In some implementations, the verifier 108 is the same model as the first LM 104. For example, the system can process the NL based input 102 using the first LM 104 to generate the initial response 106. In some versions of those implementations, the first LM 104 can then process the initial response 106 to generate the verification score 110 indicating whether the initial response 106 is responsive to the NL based input 102. In some other implementations, the verifier 108 is a separate model, separate from both the first LM 104 and the second LM, where the independent verifier 108 processes the initial response 106 to generate the verification score 110 indicating whether the initial response 106 is responsive to the NL based input 102.

Determining whether the initial response 106 is responsive to the NL based input 102 can be framed as an entailment task with the objective of determining if the initial response 106, generated based on processing the NL based input 102 using the first LM 104, aligns with provided context. However, the output generated using the verifier 108 potentially includes inconsistency and/or noise. Accordingly, meta-verifier 112 can be used as a secondary evaluation mechanism to vet the verification score 110.

In some implementations, meta-verifier 112 can process the verification score 110, the initial response 106 (not depicted), the NL based input 102 (not depicted) additional or alternative data, and/or combinations thereof to determine whether to render the initial response or whether to generate an additional response (where the additional response is generated based on processing the NL based input 102 using the second LM). In some implementations, the meta-verifier 112 is a simple classifier. In some other implementations, the meta-verifier 112 is a Partially Observable Markov Decision Processed-based (POMDP-based) classifier, where the POMDP-based classifier can determine a classification of the NL based input 102 of one of simple, complex, or unsolvable. As illustrated in example 100 of FIG. 1A, the system determines the NL based input 102 is simple or unsolvable. Therefore the system refrains from generating the additional response and renders output based on the initial response 114.

FIG. 1B illustrates an example 150 of rendering an additional response in accordance with various implementations. In some implementations, the system can process the NL based input 102 using the first LM 104 to generate the initial response 106; process at least the initial response using the verifier 108 to generate the verification score 110; and process at least the verification score 110 using the meta-verifier 112 as described herein with respect to FIG. 1A.

The system can determine to process the NL based input 102 using the second LM 152 to generate an additional response 154. In some implementations, the second LM 152 is a larger language model than the first LM, where the second LM 152 can process LM input (not depicted) in addition to the NL based input 102. In some of those implementations, the LM input can include the NL based input, context input, an instruction to evaluate the initial response, one or more additional or alternative inputs, search result documents or other documents, and/or combinations thereof. For example, the context input can include a client device context (associated with the context of the client device of the user), a user context (associated with the context of the user of the client device), a dialog context (associated with context of an ongoing dialog of the user of the client device), additional or alternative context, and/or combinations thereof. In some implementations, the system can render the additional response 156.

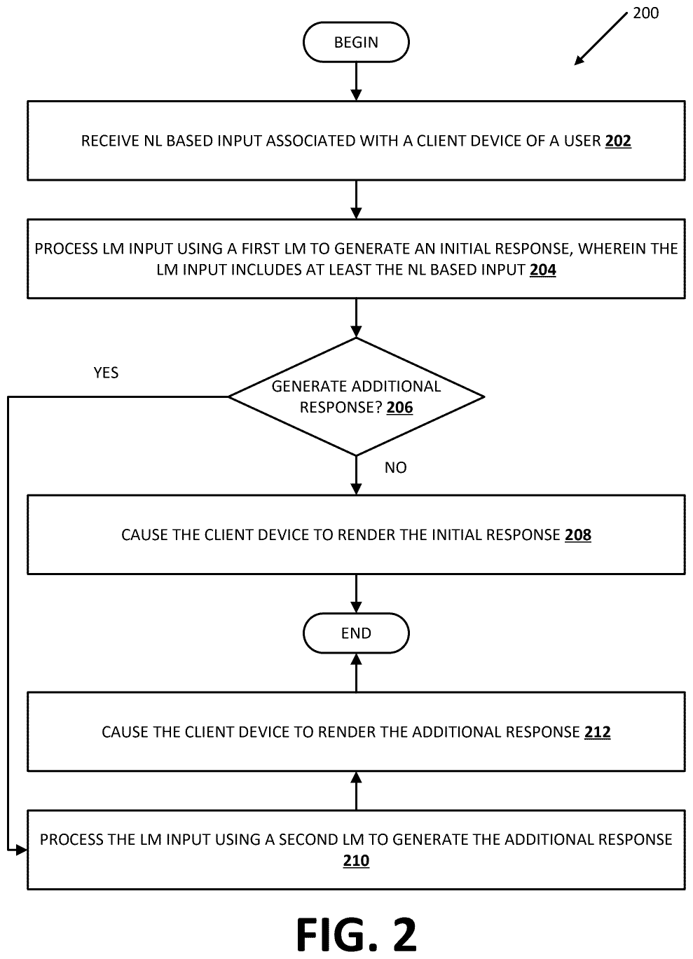

FIG. 2 is a flowchart illustrating an example process 200 in accordance with various implementations described herein. For convenience, the operations of the process 200 are described with reference to a system that performs the operations. This system may include various components of various computer systems, such as one or more components of client device 402 and/or computing system 510. Moreover, while operations of process 200 are shown in a particular order, this is not meant to be limiting. One or more operations can be reordered, omitted or added.

At block 202, the system receives NL based input associated with a client device of a user. In some implementations, the NL based input can be textual input from the user of a client device. In some other implementations, the NL based input can be a text representation of a spoken utterance (e.g., the text representation is generated based on processing audio data, capturing the spoken utterance, using a speech recognition model; the text representation is generated based on processing the audio data, capturing the spoken utterance, using a language model; etc.).

At block 204, the system processes LM input using a first LM (e.g., first LM 104 of FIGS. 1A and 1B) to generate an initial response, where the LM input includes at least the NL based input. In addition to the NL based input, the LM input can include context input, an instruction to evaluate the initial response, one or more additional or alternative inputs, and/or combinations thereof. For example, the context input can include a client device context (associated with the context of the client device of the user), a user context (associated with the context of the user of the client device), a dialog context (associated with context of an ongoing dialog of the user of the client device), additional or alternative context, search result documents or other documents, and/or combinations thereof. In some implementations, the first LM is a smaller language model, where the SLM model is “smaller” relative to the LLM in that it includes fewer parameters and/or is more computationally efficient.

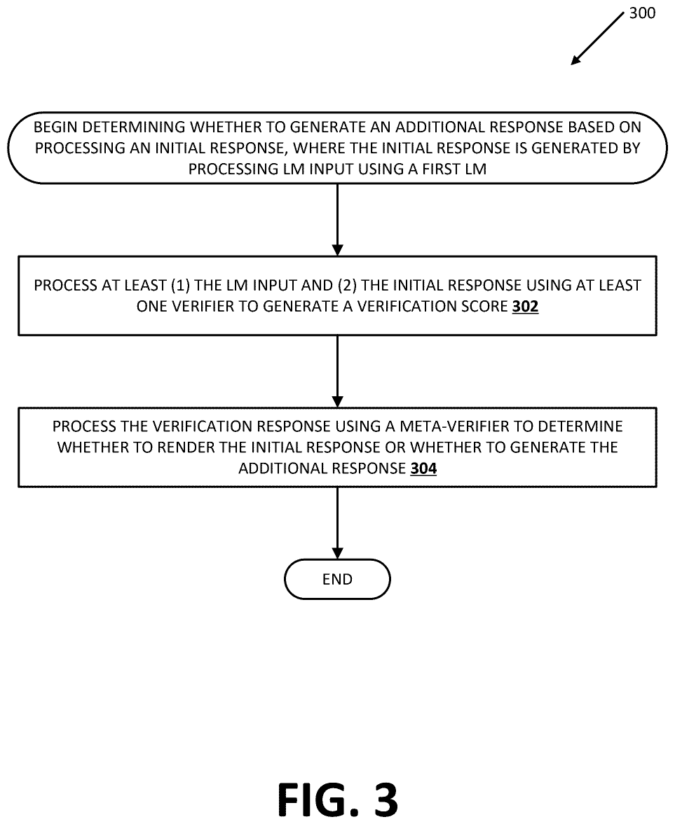

At block 206, the system determines whether to generate an additional response. If the system determines not to generate an additional response, the system proceeds to block 208 and causes the client device to render the initial response before the process ends. In some implementations, the system can determine whether to generate the additional response in accordance with process 300 described herein with respect to FIG. 3.

If the system determines to generate an additional response, the system proceeds to block 210. At block 210, the system processes the LM input using a second LM (e.g., second LM 152 of FIG. 1B) to generate the additional response. At block 212, the system causes the client device to render the additional response.

For example, the system can receive NL based input of “Whose lost work was discovered in a dusty attic in 1980?” with contextual information of “The manuscript, discovered in 1980 in a dusty attic, turned out to be a lost work of Shakespeare.” The system can process the NL based input and the contextual information using the first LM to generate the initial response of “Shakespeare”. In some implementations, the system can process the initial response of “Shakespeare”, the NL based input of “Whose lost work was discovered in a dusty attic in 1980?” and/or the context information of “The manuscript, discovered in 1980 in a dusty attic, turned out to be a lost work of Shakespeare” using the one or more verifiers and/or the meta-verifier to determine the initial response is accurate and to render output based on the initial response of “Shakespeare”.

As an alternative example, the system can receive NL based input of “In which month does the celestial event, the Pink Moon occur?” with contextual information of “The celestial event, known as the Pink Moon, is unique to the month of April and has cultural significance in many indigenous tribes”. The system can process the NL based input and the contextual information using the first LM to generate initial output of “July”. In some implementations, the system can process the initial response of “July”, the NL based input of “In which month does the celestial event, the Pink Moon occur?” and/or the contextual information of “The celestial event, known as the Pink Moon, is unique to the month of April and has cultural significant in many indigenous tribes” using the one or more verifiers and/or the meta-verifier to determine the initial response is incorrect. In some of those implementations, the system can process the NL based input of “In which month does the celestial event, the Pink Moon occur?” with contextual information of “The celestial event, known as the Pink Moon, is unique to the month of April and has cultural significance in many indigenous tribes” using the second

LM to generate additional output of “April”. Additionally or alternatively, the system can render output based on the additional output of “April”.

FIG. 3 is a flowchart illustrating an example process 300 in accordance with various implementations described herein. For convenience, the operations of the process 300 are described with reference to a system that performs the operations. This system may include various components of various computer systems, such as one or more components of client device 402 and/or computing system 510. Moreover, while operations of process 300 are shown in a particular order, this is not meant to be limiting. One or more operations can be reordered, omitted or added.

In some implementations, the system begins determining whether to generate an additional response based on processing an initial response, where the initial response is generated by processing LM input using a first LM. For example, the system can begin to determine whether to generate an additional response in accordance with block 206 described herein with respect to FIG. 2.

At block 302, the system processes at least (1) the LM input and (2) the initial response using at least one verifier to generate a verification score.

In some implementations, the at least one verifier is the first LM, where the first LM input processes: (1) the LM input; (2) the initial response; and (3) an instruction to evaluate the initial response to generate the verification score. Additionally or alternatively, the at least one verifier is a simple classifier. In some of those implementations, the verification score is a binary measure (e.g., 0/1; positive/negative; −5/+5; etc.) that indicates whether the initial response is responsive to the NL based input. In some other implementations, the verification score is a non-binary numerical measure (e.g., a value from 0-100, a percent, etc.) that indicates an extent to which the initial response is responsive to the NL based input.

At block 304, the system processes the verification score using a meta-verifier to determine whether to render the initial response or whether to generate the additional response, where the meta-verifier is distinct from both the first LM and the second LM. In some implementations, the meta-verifier is a simple classifier. In some other implementations, the meta-verifier is a Partially Observable Markov Decision Process-based (POMDP-based) classifier that can be used to classify the NL based input as simple, complex, or unsolvable. If the POMDP-based classifier determines a simple classification, the system can determine to not generate the additional response and to render output based on the initial response. Additionally or alternatively, if the POMDP-based classifier determines a complex classification, the system can determine to generate the additional response and to render output based on the additional response. Furthermore, if the POMDP-based classifier determines an unsolvable classification, the system can determine to not generate the additional response. In some of those implementations, when the system determines an unsolvable classification, the system can render output indicating an error, can render output based on the initial response, and/or render output indicating the error and output based on the initial response.

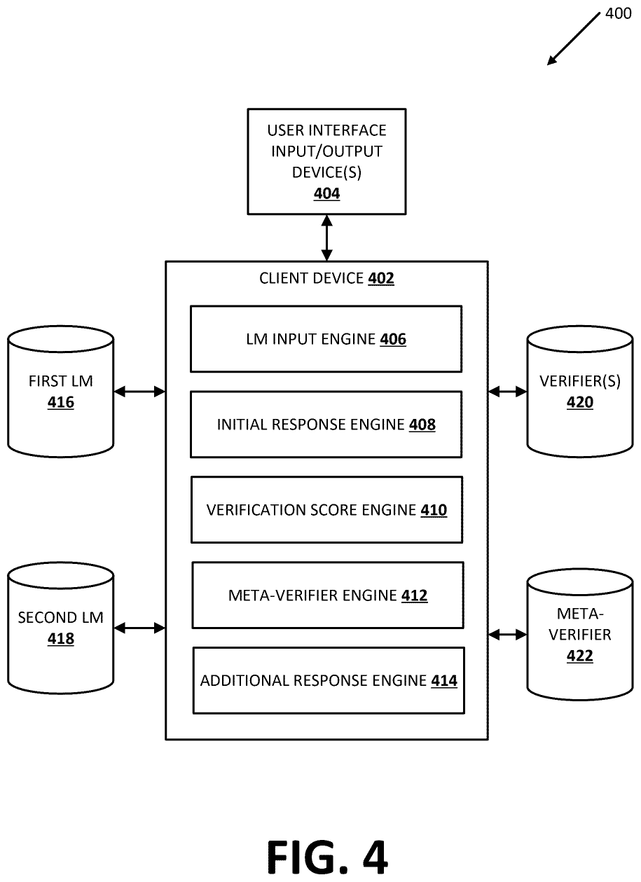

FIG. 4 is a block diagram of an example environment 400 that demonstrates various aspects of the present disclosure, and in which implementations disclosed herein can be depicted. The example environment 400 includes a client device 402, user interface input/output device(s) 404, one or more additional or alternative components (not depicted), and/or combinations thereof. The client device 402 includes LM input engine 406, initial response engine 408, verification score engine 410, meta-verifier engine 412, additional response engine 414, one or more additional or alternative engines (not depicted), and/or combinations thereof. Additionally or alternatively, the client device 402 may be associated with first LM 416, second LM 418, one or more verifiers 420, meta-verifier 422, one or more additional or alternative components, and/or combinations thereof.

In some implementations, client device 402 and/or additional or alternative components may be communicatively coupled with each other via one or more networks, such as one or more wired or wireless local area networks (“LANs,” including Wi-Fi LANs, mesh networks, Bluetooth, near-field communication, etc.) or wide area networks (“WANs”, including the Internet).

In some implementations, the client device 402 may include one or more user interface input/output devices 404, which may include, for example, a physical keyboard, a touch screen (e.g., implementing a virtual keyboard or other textual input mechanisms), a microphone, a camera, a display screen, and/or speaker(s). The user interface input/output device(s) 404 may be incorporated with one or more client devices 402 of a user. For example, a mobile phone of the user may include the user interface input output devices; a standalone digital assistant hardware device may include the user interface input/output device; a first computing device may include the user interface input device(s) and a separate computing device may include the user interface output device(s); etc. In some implementations, all or aspects of client device 402 may be implemented on a computing system that also contains the user interface input/output devices.

Some non-limiting examples of client device 402 include one or more of: a desktop computing device, a laptop computing device, a standalone hardware device at least in part dedicated to an automated assistant, a tablet computing device, a mobile phone computing device, a computing device of a vehicle (e.g., an in-vehicle communications system, and in-vehicle entertainment system, an in-vehicle navigation system, an in-vehicle navigation system), or a wearable apparatus of the user that includes a computing device (e.g., a watch of the user having a computing device, glasses of the user having a computing device, a virtual or augmented reality computing device). Additional and/or alternative computing systems may be provided. Client device 402 may include one or more memories for storage of data and software applications, one or more processors for accessing data and executing applications, and other components that facilitate communication over a network. The operations performed by client device 402 may be distributed across multiple computing devices. For example, computing programs running on one or more computers in one or more locations can be coupled to each other through a network.

In some implementations, LM input engine 406 can identify LM input. In some implementations, the LM input can include the NL based input (e.g., NL based input provided by a user), contextual information, an initial response, an instruction to evaluate an initial response, additional or alternative input, and/or combinations thereof. Initial response engine 408 can process the LM input using the first LM 416 to generate an initial response. For example, the initial response engine 408 can process the NL based input and contextual information using the first LM 416 to generate the initial response.

In some implementations, verification score engine 410 can process the initial response, the NL based input, the contextual input, evaluation instructions, additional or alternative LM input, and/or combinations thereof using one or more verifiers 420 to generate a verification score. The verification score indicates whether the initial response is responsive to the NL based input. In some implementations, the verification score is a binary measure, indicating whether the initial response is responsive to the NL based input. In some other implementations, the verification score is a non-binary numerical measure that indicates the extent to which the initial response is responsive to the NL based input. In some implementations, at least one of the verifiers 420 are a simple classifier and/or a language model distinct from both the first LM 416 and the second LM 418. In some other implementations, verification score engine 410 can generate the verification score based on processing using the first LM 416.

Additionally or alternatively, meta-verifier engine 412 can process the base NL input, the initial response, the contextual information, the verification score, additional or alternative input, and/or combinations thereof using the meta-verifier 422 to determine whether to generate an additional response. In some implementations, the meta-verifier 422 is a simple classifier. In some other implementations, the meta-verifier 422 is a Partially Observable Markov Decision Process (POMDP-based) classifier.

If the system determines not to generate an additional response, initial response engine 408 can render output using one or more user interface output devices 404 based on the initial response. If the system determines to generate an additional response, additional response engine 414 can process the LM input using the second LM 418 to generate the additional response. Output can be rendered to the user via one or more user interface output devices 404.

Although FIG. 4 is described with respect to a single client device having a single user, it should be understood that is for the sake of example and is not meant to be limiting. For example, one or more additional client devices of a user can also implement the techniques described herein. For instance, the client device 402, the one or more additional client devices, and/or any other computing devices of the user can form an ecosystem of devices that can employ techniques described herein. These additional client devices and/or computing devices may be in communication with the client device 402 (e.g., over one or more network(s)). As another example, a given client device can be utilized by multiple users in a shared setting (e.g., in a household environment, in an enterprise or work environment, in a hospitality environment, etc.).

Moreover, although FIG. 4 is described with respect to operations of various engines being executed at the client device 402, it should be understood that is for the sake of example and is not meant to be limiting. For example, the initial response engine 408, the verification score engine 410, and the meta-verifier engine 412 may be implemented locally at the client device 402, but the additional response engine 414 may be implemented by a remote computing device (e.g., a high performance server or cluster of high performance servers) accessible over one or more wired or wireless local area networks. As another example, the LM input engine 406, the initial response engine 408, the verification score engine 410, the meta-verifier engine 412, and the additional response engine 414 may each be implemented by a remote computing device (e.g., a high performance server or cluster of high performance servers). Accordingly, the configuration depicted in FIG. 4 is not meant to be limiting.

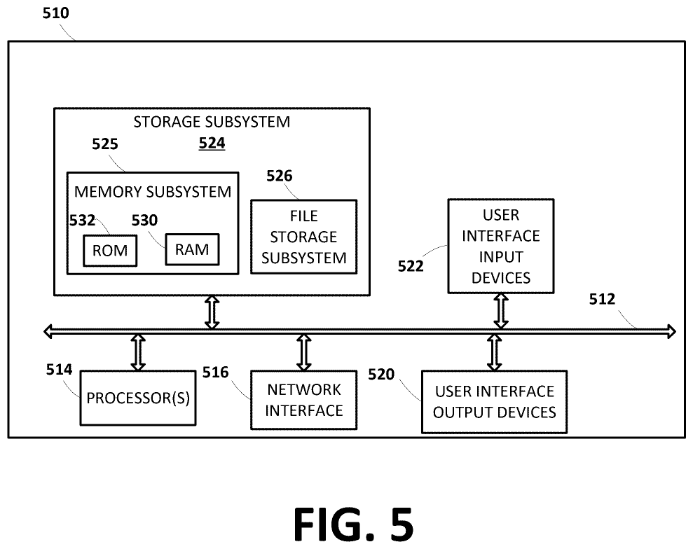

Turning now to FIG. 5, a block diagram of an example computing device 510 that may optionally be utilized to perform one or more aspects of techniques described herein is depicted. In some implementations, one or more of a client device, cloud-based automated assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 4.

These software modules are generally executed by processor 814 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple buses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, the method includes receiving natural language (NL) based input associated with a client device of a user. In some implementations, the method includes generating, based on processing language model (LM) input using a first LM, an initial response that is predicted to be responsive to the NL based input, the LM input including at least the NL based input. In some implementations, the method includes determining, based on processing at least the initial response, whether to cause the initial response to be rendered at the client device or whether to generate an additional response that is also predicted to be responsive to the NL based input and that is generated based on processing the LM input using a second LM that is in addition to the first LM. In some implementations, determining whether to cause the initial response to be rendered at the client device or whether to generate the additional response includes processing, using at least one verifier, at least the LM input and the initial response to generate a corresponding verification score for the initial response. In some implementations, the method includes processing, using a meta-verifier that is in addition to the at least one verifier, the corresponding verification score for the initial response to determine whether to cause the initial response to be rendered at the client device or whether to generate the additional response. In some implementations, in response to determining to generate the additional response, the method includes generating, based on processing the LM input using the second LM, the additional response. In some implementations, the method includes causing the additional response, and in lieu of the initial response, to be visually and/or audibly rendered at the client device.

These and other implementations of technology disclosed herein can optionally include one or more of the following features.

In some implementations, the first LM is a smaller language model (SLM), and wherein the second LM is a larger language model (LLM). In some versions of those implementations, the SLM includes fewer parameters than the LLM. In some versions of those implementations, the SLM is more computationally efficient than the LLM.

In some implementations, generating the initial response that is predicted to be responsive to the NL based input includes processing, using the first LM, the LM input to generate first LM output. In some implementations, the method further includes determining, based on the first LM output, the initial response. In some versions of those implementations, the LM input further includes a context, where the context includes one or more of: a client device context associated with context of the client device of the user, a user context associated with context of the user of the client device, or a dialog context associated with context of an ongoing dialog of the user of the client device.

In some implementations, the at least one verifier is the first LM, and wherein processing at least the LM input and the initial response to generate the corresponding verification score for the initial response using the at least one verifier includes, subsequent to generating the initial response, processing, using the first LM, at least the LM input and the initial response to generate the corresponding verification score for the initial response. In some versions of those implementations, the LM input further includes a context, and wherein the context includes one or more of: a client device context associated with context of the client device of the user, a user context associated with context of the user of the client device, or a dialog context associated with context of an ongoing dialog of the user of the client device. In some versions of those implementations, the LM input further includes an instruction to evaluate the initial response given at least the LM input and the initial response. In some versions of those implementations, the evaluation of the initial response given at least the LM input and the initial response indicates whether the initial response is responsive to the NL based input. In some versions of those implementations, the evaluation of the initial response that indicates whether the initial response is responsive to the NL based input is a corresponding binary measure that indicates whether the initial response is responsive to the NL based input. In some versions of those implementations, the evaluation of the initial response that indicates whether the initial response is responsive to the NL based input is a corresponding non-binary numerical measure that indicates an extent to which the initial response is responsive to the NL based input.

In some implementations, the at least one verifier is an independent verifier that is separate from both the first LM and the second LM, and wherein processing at least the LM input and the initial response to generate the corresponding verification score for the initial response using the at least one verifier includes, subsequent to generating the initial response, processing, using the independent verifier, at least the LM input and the initial response to generate the corresponding verification score for the initial response. In some versions of those implementations, the LM input further includes a context, and wherein the context includes one or more of: a client device context associated with context of the client device of the user, a user context associated with context of the user of the client device, or a dialog context associated with context of an ongoing dialog of the user of the client device. In some versions of those implementations, the LM input further includes an instruction to evaluate the initial response given at least the LM input and the initial response. In some versions of those implementations, the evaluation of the initial response given at least the LM input and the initial response indicates whether the initial response is responsive to the NL based input. In some versions of those implementations, the evaluation of the initial response that indicates whether the initial response is responsive to the NL based input is a corresponding binary measure that indicates whether the initial response is responsive to the NL based input. In some versions of those implementations, the evaluation of the initial response that indicates whether the initial response is responsive to the NL based input is a corresponding non-binary numerical measure that indicates an extent to which the initial response is responsive to the NL based input.

In some implementations, the meta-verifier is an independent meta-verifier that is separate from both the first LM and the second LM, wherein the independent meta-verifier is a simple classifier, wherein the corresponding verification score is a corresponding binary measure that indicates whether the initial response is responsive to the NL based input, and wherein processing the corresponding verification score for the initial response to determine whether to cause the initial response to be rendered at the client device or whether to generate the additional response and using the meta-verifier includes processing, using the simple classifier, the corresponding binary measure that indicates whether the initial response is responsive to the NL based input to generate simple classifier output. In some implementations, in response to determining that the simple classifier output indicates that the initial response is responsive to the NL based input, the method further includes refraining from generating the additional response. In some implementations, the method further includes determining to cause the initial response to be rendered at the client device. In some implementations, the method further includes causing the initial response to be visually and/or audibly rendered at the client device. In some versions of those implementations, in response to determining that the simple classifier output does not indicate that the initial response is responsive to the NL based input, the method further includes determining to generate the additional response.

In some implementations, the meta-verifier is an independent meta-verifier that is separate from both the first LM and the second LM, wherein the independent meta-verifier is a simple classifier, wherein the corresponding verification score is a corresponding non-binary numerical measure that indicates whether the initial response is responsive to the NL based input, and wherein processing the corresponding verification score for the initial response to determine whether to cause the initial response to be rendered at the client device or whether to generate the additional response and using the meta-verifier includes processing, using the simple classifier, the corresponding non-binary numerical measure that indicates whether the initial response is responsive to the NL based input to generate simple classifier output. In some implementations, in response to determining that the simple classifier output satisfies a threshold, the method further includes refraining from generating the additional response. In some implementations, the method further includes determining to cause the initial response to be rendered at the client device. In some implementations, the method further includes causing the initial response to be visually and/or audibly rendered at the client device. In some versions of those implementations, in response to determining that the simple classifier output fails to satisfy the threshold, the method further includes determining to generate the additional response.

In some implementations, the meta-verifier is an independent meta-verifier that is separate from both the first LM and the second LM, wherein the independent meta-verifier is a Partially Observable Markov Decision Process-based (POMDP-based) classifier, wherein the corresponding verification score is a corresponding non-binary numerical measure that indicates whether the initial response is responsive to the NL based input, and wherein processing the corresponding verification score for the initial response to determine whether to cause the initial response to be rendered at the client device includes processing, using the POMDP-based classifier, POMDP input to determine a classification, wherein the classification is one of: simple, complex, or unsolvable. In some implementations, in response to determining that the classification is simple or unsolvable, the method further includes refraining from generating the additional response. In some implementations, the method further includes determining to cause the initial response to be rendered at the client device. In some implementations, the method further includes causing the initial response to be visually and/or audibly rendered at the client device. In some versions of those implementations, in response to determining that the classification is complex, the method further includes determining to generate the additional response. In some versions of those implementations, the POMDP input includes the corresponding non-binary numerical measure that indicates whether the initial response is responsive to the NL based input. In some versions of those implementations, the POMDP input further includes one or more of: the LM input or the initial response.

In some implementations, prior to causing the additional response, and in lieu of the initial response, to be visually and/or audibly rendered at the client device, the method further includes determining, based on processing the additional response whether to cause the additional response to be rendered at the client device or whether to generate a further additional response that is also predicted to be responsive to the NL based input and that is generated based on processing the LM input using a third LM that is in addition to both the first LM and the second LM, wherein determining whether to cause the additional response to be rendered at the client device or whether to generate the further additional response includes processing, using the at least one verifier, the LM input and the additional response to generate an additional corresponding verification score for the additional response. In some implementations, the method further includes processing, using the meta-verifier that is in addition to the at least one verifier, the additional corresponding verification score for the additional response to determine whether to cause the additional response to be rendered at the client device or whether to generate the further additional response. In some implementations, in response to determining to cause the additional response to be rendered at the client device, the method further includes causing the additional response, and in lieu of the initial response, to be visually and/or audibly rendered at the client device. In some versions of those implementations, in response to determining to generate the further additional response, the method further includes generating, based on processing the LM input using the third LM, the further additional response. In some implementations, the method further includes causing the further additional response, and in lieu of both the initial response and the additional response, to be visually and/or audibly rendered at the client device.

In some implementations, the at least one verifier includes at least a first verifier and a second verifier, and wherein processing the LM input and the initial response to generate the corresponding verification score for the initial response includes processing, using the first verifier, the LM input and the initial response to generate a first verification score for the initial response. In some implementations, the method further includes processing, using the second verifier, the LM input and the initial response to generate a second verification score for the initial response. In some versions of those implementations, processing the corresponding verification score for the initial response to determine whether to cause the initial response to be rendered at the client device or whether to generate the additional response includes processing, using the meta-verifier, at least the first verification score for the initial response and the second verification score for the initial response to determine whether to cause the initial response to be rendered at the client device or whether to generate the additional response.

In some implementations, the corresponding verification score is noisy, and wherein processing the corresponding verification score for the initial response to determine whether to cause the initial response to be rendered at the client device or whether to generate the additional response de-noises the corresponding verification score.

In some implementations, a method implemented by one or more processors is provided, the method includes receiving natural language (NL) based input associated with a client device of a user. In some implementations, the method further includes generating, based on processing language model (LM) input using a first LM, an initial response that is predicted to be responsive to the NL based input, the LM input including at least the NL based input. In some implementations, the method further includes determining, based on processing at least the initial response, whether to cause the initial response to be rendered at the client device or whether to generate an additional response that is also predicted to be responsive to the NL based input and that is generated based on processing the LM input using a second LM that is in addition to the first LM, wherein determining whether to cause the initial response to be rendered at the client device or whether to generate the additional response includes processing, using at least one verifier, the LM input and the initial response to generate a corresponding verification score for the initial response. In some implementations, the method further includes processing, using a meta-verifier that is in addition to the at least one verifier, the corresponding verification score for the initial response to determine whether to cause the initial response to be rendered at the client device or whether to generate the additional response. In some implementations, in response to determining to cause the initial response to be rendered at the client device, the method further includes causing the initial response to be visually and/or audibly rendered at the client device.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving natural language (NL) based input associated with a client device of a user;
generating, based on processing language model (LM) input using a first LM, an initial response that is predicted to be responsive to the NL based input, the LM input including at least the NL based input;
determining, based on processing at least the initial response, whether to cause the initial response to be rendered at the client device or whether to generate an additional response that is also predicted to be responsive to the NL based input and that is generated based on processing the LM input using a second LM that is in addition to the first LM, wherein determining whether to cause the initial response to be rendered at the client device or whether to generate the additional response comprises:
processing, using at least one verifier, at least the LM input and the initial response to generate a corresponding verification score for the initial response; and
processing, using a meta-verifier that is in addition to the at least one verifier, the corresponding verification score for the initial response to determine whether to cause the initial response to be rendered at the client device or whether to generate the additional response; and
in response to determining to generate the additional response:
generating, based on processing the LM input using the second LM, the additional response; and
causing the additional response, and in lieu of the initial response, to be visually and/or audibly rendered at the client device.

2. The method of claim 1, wherein the first LM is a smaller language model (SLM), and wherein the second LM is a larger language model (LLM).

3. The method of claim 2, wherein the SLM includes fewer parameters than the LLM.

4. The method of claim 2, wherein the SLM is more computationally efficient than the LLM.

5. The method of claim 1, wherein generating the initial response that is predicted to be responsive to the NL based input comprises:
processing, using the first LM, the LM input to generate first LM output; and
determining, based on the first LM output, the initial response.

6. The method of claim 5, wherein the LM input further includes a context, and wherein the context includes one or more of: a client device context associated with context of the client device of the user, a user context associated with context of the user of the client device, or a dialog context associated with context of an ongoing dialog of the user of the client device.

7. The method of claim 1, wherein the at least one verifier is the first LM, and wherein processing at least the LM input and the initial response to generate the corresponding verification score for the initial response using the at least one verifier comprises:
subsequent to generating the initial response:
processing, using the first LM, at least the LM input and the initial response to generate the corresponding verification score for the initial response.

8. The method of claim 1, wherein the at least one verifier is an independent verifier that is separate from both the first LM and the second LM, and wherein processing at least the LM input and the initial response to generate the corresponding verification score for the initial response using the at least one verifier comprises:
subsequent to generating the initial response:
processing, using the independent verifier, at least the LM input and the initial response to generate the corresponding verification score for the initial response.

9. The method of claim 8, wherein the LM input further includes a context, and wherein the context includes one or more of: a client device context associated with context of the client device of the user, a user context associated with context of the user of the client device, or a dialog context associated with context of an ongoing dialog of the user of the client device.

10. The method of claim 8, wherein the LM input further includes an instruction to evaluate the initial response given at least the LM input and the initial response.

11. The method of claim 1, wherein the meta-verifier is an independent meta-verifier that is separate from both the first LM and the second LM, wherein the independent meta-verifier is a simple classifier, wherein the corresponding verification score is a corresponding binary measure that indicates whether the initial response is responsive to the NL based input, and wherein processing the corresponding verification score for the initial response to determine whether to cause the initial response to be rendered at the client device or whether to generate the additional response and using the meta-verifier comprises:
processing, using the simple classifier, the corresponding binary measure that indicates whether the initial response is responsive to the NL based input to generate simple classifier output; and
in response to determining that the simple classifier output indicates that the initial response is responsive to the NL based input:
refraining from generating the additional response;
determining to cause the initial response to be rendered at the client device; and
causing the initial response to be visually and/or audibly rendered at the client device.

12. The method of claim 11, further comprising:
in response to determining that the simple classifier output does not indicate that the initial response is responsive to the NL based input:
determining to generate the additional response.

13. The method of claim 1, wherein the meta-verifier is an independent meta-verifier that is separate from both the first LM and the second LM, wherein the independent meta-verifier is a simple classifier, wherein the corresponding verification score is a corresponding non-binary numerical measure that indicates whether the initial response is responsive to the NL based input, and wherein processing the corresponding verification score for the initial response to determine whether to cause the initial response to be rendered at the client device or whether to generate the additional response and using the meta-verifier comprises:
processing, using the simple classifier, the corresponding non-binary numerical measure that indicates whether the initial response is responsive to the NL based input to generate simple classifier output; and
in response to determining that the simple classifier output satisfies a threshold:
refraining from generating the additional response;
determining to cause the initial response to be rendered at the client device; and
causing the initial response to be visually and/or audibly rendered at the client device.

14. The method of claim 13, further comprising:
in response to determining that the simple classifier output fails to satisfy the threshold:
determining to generate the additional response.

15. The method of claim 1, wherein the meta-verifier is an independent meta-verifier that is separate from both the first LM and the second LM, wherein the independent meta-verifier is a Partially Observable Markov Decision Process-based (POMDP-based) classifier, wherein the corresponding verification score is a corresponding non-binary numerical measure that indicates whether the initial response is responsive to the NL based input, and wherein processing the corresponding verification score for the initial response to determine whether to cause the initial response to be rendered at the client device or whether to generate the additional response and using the meta-verifier comprises:
processing, using the POMDP-based classifier, POMDP input to determine a classification, wherein the classification is one of: simple, complex, or unsolvable. in response to determining that the classification is simple or unsolvable:
refraining from generating the additional response;
determining to cause the initial response to be rendered at the client device; and
causing the initial response to be visually and/or audibly rendered at the client device.

16. The method of claim 15, further comprising:
in response to determining that the classification is complex:
determining to generate the additional response.

17. The method of claim 15, wherein the POMDP input includes the corresponding non-binary numerical measure that indicates whether the initial response is responsive to the NL based input.

18. The method of claim 17, wherein the POMDP input further includes one or more of: the LM input or the initial response.

19. The method of claim 1, further comprising:
prior to causing the additional response, and in lieu of the initial response, to be visually and/or audibly rendered at the client device:
determining, based on processing the additional response whether to cause the additional response to be rendered at the client device or whether to generate a further additional response that is also predicted to be responsive to the NL based input and that is generated based on processing the LM input using a third LM that is in addition to both the first LM and the second LM, wherein determining whether to cause the additional response to be rendered at the client device or whether to generate the further additional response comprises:
processing, using the at least one verifier, the LM input and the additional response to generate an additional corresponding verification score for the additional response; and
processing, using the meta-verifier that is in addition to the at least one verifier, the additional corresponding verification score for the additional response to determine whether to cause the additional response to be rendered at the client device or whether to generate the further additional response; and
in response to determining to cause the additional response to be rendered at the client device:
causing the additional response, and in lieu of the initial response, to be visually and/or audibly rendered at the client device.

20. The method of claim 19, further comprising:
in response to determining to generate the further additional response:
generating, based on processing the LM input using the third LM, the further additional response; and
causing the further additional response, and in lieu of both the initial response and the additional response, to be visually and/or audibly rendered at the client device.

21. The method of claim 1, wearing the corresponding verification score is noisy, and wherein processing the corresponding verification score for the initial response to determine whether to cause the initial response to be rendered at the client device or whether to generate the additional response de-noises the corresponding verification score.
